(19) United States
(12) Patent Application Publication
(10) Pub. No.: US 2025/0183526 A1
(43) Pub. Date: Jun. 5, 2025

(54) SWITCH DEVICE, ANTENNA AND ELECTRONIC DEVICE

(71) Applicants: Beijing BOE Technology Development Co., Ltd., Beijing (CN); BOE Technology Group Co., Ltd., Beijing (CN)

(72) Inventors: Long Wang, Beijing (CN); Feng Wang, Beijing (CN); Yidan Peng, Beijing (CN); Shuaipeng Tao, Beijing (CN); Jian Zhou, Beijing (CN); Yanzhao Li, Beijing (CN)

(73) Assignees: Beijing BOE Technology Development Co., Ltd., Beijing (CN); BOE Technology Group Co., Ltd., Beijing (CN)

(21) Appl. No.: 18/685,941

(22) PCT Filed: Feb. 24, 2023
(86) PCT No.: PCT/CN2023/078055

§ 371 Date: Feb. 23, 2024

(51) Int. Cl. H01Q 1/50; H01H 9/02; H01Q 1/22

(52) U.S. Cl. CPC H01Q 1/50; H01H 9/02; H01Q 1/22

(57) ABSTRACT

A switch device, an antenna and an electronic device are provided by the present disclosure. The switch device includes a base plate, a first conducting layer and a second conducting layer, the first conducting layer and the second conducting layer are sequentially arranged in layer configuration on the base plate, the first conducting layer includes a first electrode, a second electrode and a bottom electrode and the second conducting layer includes an elastic arm; the first electrode and the second electrode are separately disposed, the elastic arm includes a connecting portion; in a direction perpendicular to the base plate, there are spaces disposed between the connecting portion and the first electrode, and between the connecting portion and the second electrode, and an orthographic projection of the connecting portion on the first conducting layer partially overlaps with the first electrode and the second electrode.

### TECHNICAL FIELD

The present disclosure relates to the technical field of antennas and, more particularly, to a switch device, an antenna and an electronic device.

### BACKGROUND

Electronic devices such as mobile phones can often be compatible with different generations of mobile communication technologies at a same time, for example, 2G, 3G, 4G and 5G are compatible at the same time. Because the different generations of the mobile communication technologies need to use different antennas, so that the quantity of antennas in the electronic device is more and more, and the space occupied by the antennas is also larger and larger.

### SUMMARY

The technical solutions employed by the present disclosure are as follows:

In an aspect, a switch device is provided, wherein the switch device includes a base plate, a first conducting layer and a second conducting layer, the first conducting layer and the second conducting layer are sequentially arranged in layer configuration on the base plate, the first conducting layer includes a first electrode, a second electrode and a bottom electrode and the second conducting layer includes an elastic arm; the first electrode and the second electrode are separately disposed, the elastic arm includes a connecting portion; in a direction perpendicular to the base plate, there are spaces disposed between the connecting portion and the first electrode, between the connecting portion and the second electrode, and between the connecting portion and the bottom electrode; and an orthographic projection of the connecting portion on the first conducting layer partially overlaps with the first electrode and the second electrode; and the orthographic projection of the connecting portion on the first conducting layer partially overlaps with the bottom electrode; when a preset voltage is introduced between the connecting portion and the bottom electrode, the connecting portion is configured to bend toward the first electrode and the second electrode, and be electrically connected to the first electrode and the second electrode, respectively.

In some embodiments, the elastic arm further includes a fixing portion connected to the connecting portion, and the fixing portion is fixed on the base plate.

In some embodiments, the connecting portion includes a first end and a second end, the fixing portion is connected to the first end of the connecting portion, and the second end of the connecting portion is suspended.

In some embodiments, the fixing portion includes a first fixing portion and a second fixing portion, and the connecting portion is connected between the first fixing portion and the second fixing portion.

In some embodiments, the first electrode and the second electrode both include a contacting portion, and the contacting portion is configured to be electrically connected to the connecting portion; and the contacting portion is located between the first fixing portion and the second fixing portion.

In some embodiments, the first conducting layer further includes an anchoring structure, and the fixing portion of the elastic arm is connected to the anchoring structure.

In some embodiments, a sacrificial layer is further disposed between the fixing portion and the anchoring structure.

In some embodiments, the first conducting layer is provided with a hollow region, and an overlapping region of an orthographic projection of the connecting portion on the base plate and an orthographic projection of the hollow region on the base plate is provided with a planarization layer; and sides that are away from the base plate of the planarization layer, the first electrode, the second electrode and the anchoring structure are aligned.

In some embodiments, the fixing portion is directly connected to one side of the anchoring structure away from the base plate.

In some embodiments, in the direction perpendicular to the base plate, a distance between a surface of one side of the connecting portion away from the base plate and the base plate is greater than or equal to a distance between a surface of one side of the fixing portion away from the base plate and the base plate.

In some embodiments, an orthographic projection of the fixing portion on the base plate is located within a range of an orthographic projection of the anchoring structure on the base plate.

In some embodiments, the connecting portion includes a first elastic sheet and a second elastic sheet that are connected to the fixing portion, respectively, and the first elastic sheet is configured to be electrically connected to the first electrode; the second elastic sheet is configured to be electrically connected to the second electrode; in a direction parallel to the base plate, the first elastic sheet and the second elastic sheet are separately disposed.

In some embodiments, the connecting portion further includes a strengthening portion connected between the first elastic sheet and the second elastic sheet, and the strengthening portion is directly connected to the fixing portion.

In some embodiments, the connecting portion of the elastic arm is provided with a releasing hole, and the releasing hole penetrates through the connecting portion in the direction perpendicular to the base plate.

In some embodiments, the releasing hole includes a strip hole extending from the fixing portion toward the first electrode or the second electrode.

In some embodiments, there is a first space disposed between the first electrode and the second electrode, and there is a second space disposed between the anchoring structure and the first electrode, and between the anchoring structure and the second electrode; and the bottom electrode is located in the first space and/or the second space.

In some embodiments, a minimum distance between the first electrode and the connecting portion, and between the second electrode and the connecting portion is less than a minimum distance between the bottom electrode and the connecting portion.

In some embodiments, the first conducting layer includes a first sub-conducting layer and a second sub-conducting layer, the first sub-conducting layer and the second sub-conducting layer are sequentially arranged in layer configuration in a direction away from the base plate; the bottom electrode is located in the first sub-conducting layer, and a position of the second sub-conducting layer opposite to the bottom electrode is hollow; and the first electrode includes a first conducting structure located in the second sub-conducting layer, and the second electrode includes a second conducting structure located in the second sub-conducting layer; when the preset voltage is introduced between the elastic arm and the bottom electrode, the connecting portion is electrically connected to the first conducting structure and the second conducting structure.

In some embodiments, one side of the bottom electrode away from the base plate is provided with an insulating layer.

In another aspect, an antenna is provided, wherein the antenna includes a plurality of switch devices stated above, the plurality of switch devices are arranged in an array, and the second electrode of the switch device is electrically connected to the first electrode of adjacent switch device; wherein the first electrode or the second electrode of one of the plurality of the switch devices is configured to be electrically connected to a feeder line.

In some embodiments, when the preset voltage is introduced between the elastic arm and the bottom electrode of the switch device, a potential of the elastic arm is lower than a potential of the bottom electrode.

In yet another aspect, an antenna is provided, wherein the antenna includes a base plate and a first conducting layer and a switch device that are disposed on the base plate; the first conducting layer includes an antenna body and an extending line, one end of the antenna body is configured to be electrically connected to a feeder line, and the other end of the antenna body and the extending line are separately disposed; and the switch device is located at an interval between the antenna body and the extending line, and is configured to be electrically connected or disconnected to the antenna body and the extending line under control of the controlling signal to change an electrical length of the antenna.

In yet another aspect, an electronic device is provided, wherein the electronic device includes an antenna stated above.

The above description is merely a summary of the technical solutions of the present application. In order to more clearly know the elements of the present application to enable the implementation according to the contents of the description, and in order to make the above and other purposes, features and advantages of the present application more apparent and understandable, the particular embodiments of the present application are provided below.

### BRIEF DESCRIPTION OF THE DRAWINGS

In order to more clearly illustrate the technical solutions of the embodiments of the present disclosure or the prior art, the figures that are required to describe the embodiments or the prior art may be briefly introduced below. Apparently, the figures that are described below are embodiments of the present disclosure, and a person skilled in the art can obtain other figures according to these figures without paying creative work.

FIG. 1 schematically shows a schematic structural diagram of an antenna;

FIG. 2 schematically shows a schematic structural diagram of another antenna;

FIG. 3 to FIG. 19 schematically show schematic structural diagrams of a switch device;

FIG. 20 and FIG. 21 schematically show a parameter diagram and a radiation efficiency diagram of an antenna; and

FIG. 22 schematically shows a flow block diagram of the method for manufacturing a switch device.

### REFERENCE NUMERALS

1—antenna body; 2—extending line; 3—switch device;
10—base plate; 20—first conducting layer; 30—elastic arm; 40—insulating layer;
50—planarization layer; 60—sacrificial layer;
20a—first sub-conducting layer; 20b—second sub-conducting layer;
21—first electrode; 21a—third conducting structure; 21b—first conducting structure;
22—second electrode; 22a—fourth conducting structure; 22b—second conducting structure;
23—bottom electrode;
24—anchoring structure; 24a—first sub-anchoring structure; 24b—second sub-anchoring structure;
25—connecting line;
31—connecting portion; 31a—first elastic sheet; 31b—second elastic sheet;
31c—strengthening portion;
32—fixing portion; 32a—first fixing portion; 32b—second fixing portion;
33—releasing hole; 33a—first releasing hole; and 33b—second releasing hole.

### DETAILED DESCRIPTION

In order to make the objects, the technical solutions and the advantages of the embodiments of the present disclosure clearer, the technical solutions of the embodiments of the present disclosure may be clearly and completely described below with reference to the drawings of the embodiments of the present disclosure. Apparently, the described embodiments are merely certain embodiments of the present disclosure, rather than all of the embodiments. All of the other embodiments that a person skilled in the art obtains on the basis of the embodiments of the present disclosure without paying creative work fall within the protection scope of the present disclosure.

An electronic device is provided by the embodiments of the present disclosure, the electronic device may be a mobile phone, a laptop, a super mobile personal computer (UMPC), netbook, a personal digital assistant (PDA), a wearable device, a virtual reality device or a mobile computing device and other devices that can be communicated with external devices through an antenna, which is not limited by the embodiments of the present disclosure. In order to facilitate the description, the present disclosure is illustrated by taking that the electronic device is the mobile phone as an example.

The electronic device includes an antenna, one end of the antenna is connected to the feeder line. When working, the antenna receives a guided wave coming from a feeder line, and transforms the guided wave into an electromagnetic wave propagating in the free space. Or, the antenna receives the electromagnetic wave propagating in the free space and transforms the electromagnetic wave into the guided wave propagating through the feeder line. As a result, it can be realized that the electronic device can be communicated with the external devices through the antennas. Exemplarily, the electronic device further includes a housing, and the antenna and the feeder line can be disposed in the housing.

With the development of the communication technology. The communication technology has developed from the first generation mobile communication technology (1G) and sequentially passed through the second generation mobile communication technology (2G), the third generation mobile communication technology (3G), the fourth generation mobile communication technology (4G), the fifth generation mobile communication technology (5G) to the sixth generation mobile communication technology (6G). In order to improve the communication capability of the electronic device, the electronic device can usually be compatible with a plurality of mobile communication technologies at the same time. For example, the electronic device is compatible with 2G, 3G, 4G and 5G at the same time.

Since different frequency bands are used in different generations of mobile communication technologies, and different lengths of antennas are needed to be used for the different frequency bands. Therefore, in order to be compatible with a plurality of mobile communication technologies, a plurality of antennas with different lengths are needed to be disposed in the electronic device, so that space occupied by the antenna in the electronic device is large and the miniaturization of the electronic device is restricted.

In view of this, in the electronic device provided by the embodiments of the present disclosure, the length of the antenna can be adjusted, so that one antenna can be adapted to a plurality of different frequency bands, the quantity of antennas in the electronic device is reduced and the space in the electronic device is saved.

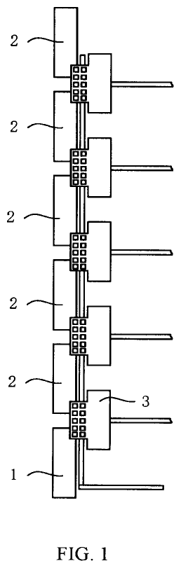

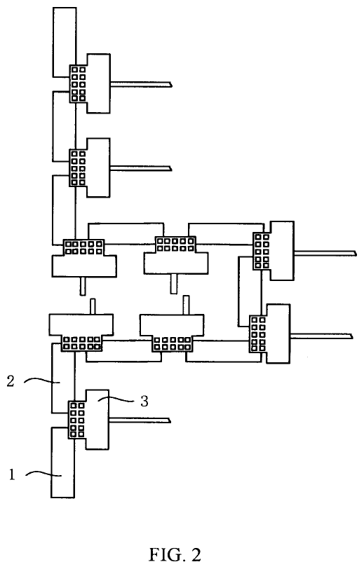

FIG. 1 is a schematic structural diagram of an antenna according to an embodiment of the present disclosure, and FIG. 2 is a schematic structural diagram of another antenna according to an embodiment of the present disclosure. As shown in FIG. 1 and FIG. 2, the antenna includes a base plate (not shown in the figure) and a first conducting layer and a switch device, the first conducting layer and the switch device are disposed on the base plate.

The base plate is used to support and be connected to the first conducting layer and the switch device 3. The base plate may be a rigid base plate or may also be a flexible base plate. When the base plate is a rigid base plate, the rigid base plate may be a glass base plate, a plastic base plate or a printed circuit board (PCB), etc., and when the base plate is a flexible base plate, the materials that form the flexible base plate may be PI (polyimide), PET (polyethylene glycol terephthalate), ultra-thin glass, etc. That the base plate is the glass base plate is only taken as an example for schematic illustration below.

The first conducting layer can be formed by patterning the conducting layer formed on the base plate. The first conducting layer can include a conducting layer or may also include a plurality of layers of sub-conducting layers sequentially arranged in layer configuration. Exemplarily, the first conducting layer includes two layers of sub-conducting layers. Wherein the sub-conducting layer directly connected to the base plate has a better adhesion, however the sub-conducting layer away from the base plate has a better conductivity.

The patterned first conducting layer includes an antenna body 1 and an extending line 2.

One end of the antenna body 1 is configured to be electrically connected to the feeder line to receive the guided wave propagating in the feeder line, or to transmit the guided wave to the feeder line. The other end of the antenna body 1 and the extending line 2 are separately disposed. The separately disposing here refers to that in the first conducting layer, the other end of the antenna body 1 is disconnected to the extending line 2, and the other end of the antenna body 1 is not electrically connected to the extending line 2.

The switch device 3 is located at an interval between the antenna body 1 and the extending line 2, and is configured to be electrically connected or disconnected to the antenna body 1 and the extending line 2 under control of the controlling signal to change an electrical length of the antenna. For example, when the frequency of the communication band used by the electronic device is high, the switch device 3 is disconnected under the control of the controlling signal, the antenna body 1 and the extending line 2 cannot be electrically connected, and the length of the antenna is shorter; when the frequency of the communication band used by the electronic device is low, the switch device 3 makes that the antenna body 1 and the extending line 2 are electrically connected under the control of the controlling signal, thereby the length of the antenna is increased.

Exemplarily, as shown in FIG. 1 and FIG. 2, the first conducting layer includes a plurality of segments of the extending lines 2, the plurality of segments of the extending lines 2 are arranged in turn, and two adjacent segments of the extending lines 2 are separately disposed (that is, the two adjacent segments of the extending lines are disconnected in the first conducting layer). The antenna includes a plurality of switch devices 3, and the switch device 3 is disposed at the interval between the two adjacent segments of the extending lines 2.

In this way, the adjustable range of the length of the antenna may be larger. For example, with the cooperation of the plurality of switch devices 3, the antenna body 1 can be connected to one segment of the extending line 2, and can also be connected to two, three, four and other segments of the extending lines 2. The more segments of the extending line 2 connected to the antenna body 1 is, the longer the length of the antenna is. In practical applications, the quantity of the segments of the extending lines 2 connected to the antenna body 1 can be determined according to the frequency of the communication frequency. For example, the lower the frequency of the communication band is, the more the quantity of the segments of the extending lines 2 connected to the antenna body 1 is.

The lengths of the plurality of segments of the extending lines 2 can be the same or may also be different.

Exemplarily, the antenna includes a plurality of segments of the extending lines 2, the plurality of segments of the extending lines 2 include the plurality of segments of the extending lines 2 with shorter lengths (e.g., the lengths are much less than the wavelength of the guided wave). By using the plurality of segments of the extending line 2 with shorter lengths, the length of the antenna can be fine-tuned.

In the related art, the antenna is a fixed length, and there are inevitable errors in the process of manufacturing the antenna, resulting in the inconsistency between the actual length of the antenna and the length of the antenna at an ideal state, so that the performance of the antenna is reduced. When the antenna includes the plurality of segments of the extending lines 2 with shorter lengths, the length of the antenna can be fine-tuned by the switch device 3 under the control of the controlling signal, so that the length of the antenna can be closer to the length of the antenna at the ideal state, the performance of the antenna is improved.

When the antenna includes the plurality of segments of the extending lines 2, the plurality of segments of the extending lines 2 can be arranged in an array in turn along a straight line, or can also be arranged in an array in turn along a curve or a broken line. The arranging way of the extending line 2 can be flexibly determined according to the space in the electronic device.

Exemplarily, as shown in FIG. 1, the plurality of segments of the extending lines 2 are arranged in an array in turn along a straight line, so that the size of the antenna in a direction perpendicular to the straight line is smaller.

Exemplarily, as shown in FIG. 2, the plurality of segments of the extending lines 2 are arranged in an array in turn along the broken line, so that the size of the antenna in a vertical direction of the figure is smaller.

The structure of the switch device 3 is not limited by the embodiments of the present disclosure, as long as the disconnection or electrical connection of the antenna body 1 and the extending line 2 can be realized under the control of the controlling signal, or the disconnection or electrical connection of two adjacent segments of the extending line 2 are realized.

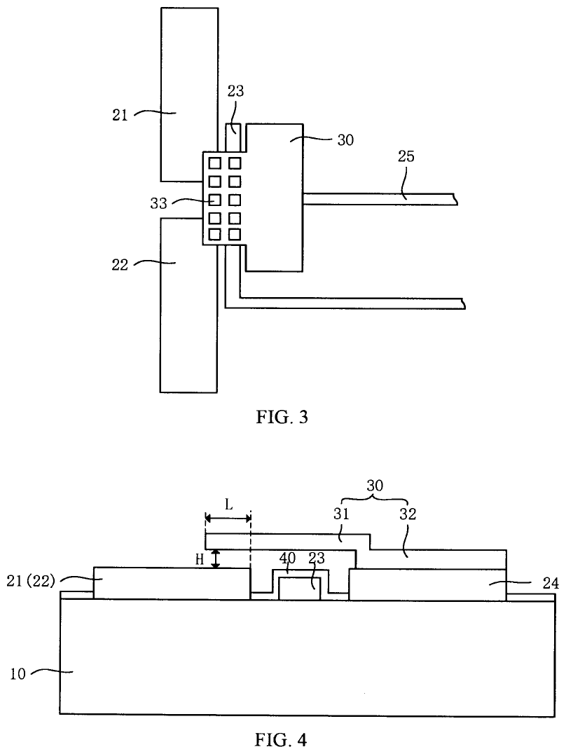

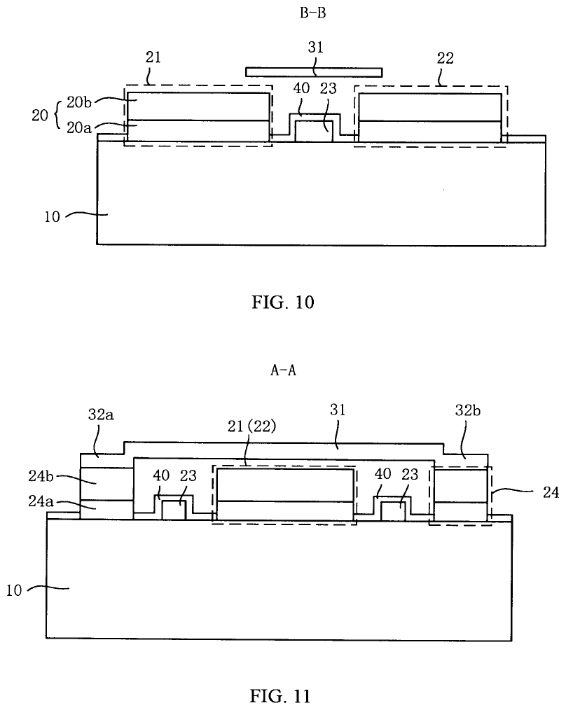

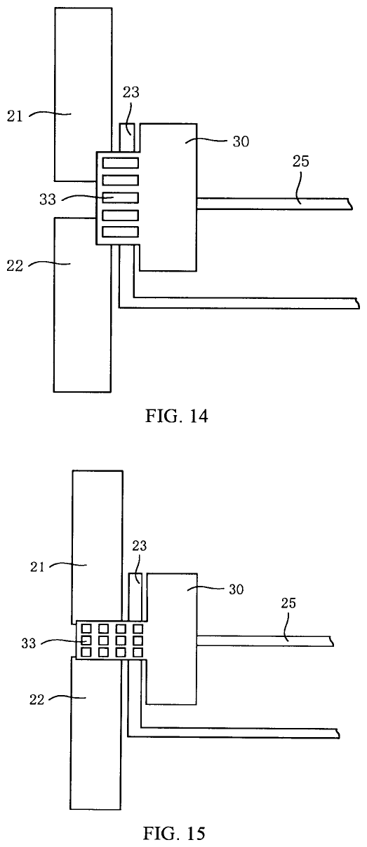

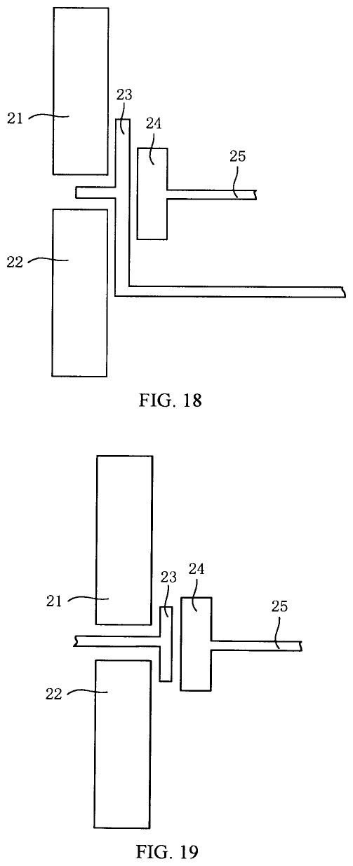

FIG. 3 to FIG. 19 are schematic structural diagrams of a switch device according to embodiments of the present disclosure. The switch device is schematically illustrated in combination with FIG. 3 to FIG. 19.

As shown in FIG. 3 to FIG. 5, the switch device includes a base plate 10, a first conducting layer 20 and a second conducting layer, the first conducting layer and the second conducting layer are sequentially arranged in layer configuration on the base plate 10.

The base plate 10 is used to support and be connected to the first conducting layer 20 and the second conducting layer. The base plate 10 may be a rigid base plate 10 or may also be a flexible base plate 10. When the base plate 10 is a rigid base plate 10, the rigid base plate 10 may be a glass base plate 10, a plastic base plate 10 or a printed circuit board (PCB), etc., and when the base plate 10 is a flexible base plate 10, the materials that form the flexible base plate 10 may be PI (polyimide), PET (polyethylene glycol terephthalate), ultra-thin glass, etc. That the base plate 10 is the glass base plate 10 is only taken as an example for schematic illustration below.

When the switch device is applied to the antenna, the base plate in the switch device and the base plate 10 in the antenna can be the same base plate, that is, the switch device and the antenna share a base plate 10. Of course, the base plate 10 of the switch device can also be different from the base plate in the antenna.

The first conducting layer 20 can be formed by patterning the conducting layer deposited on the base plate 10. The first conducting layer 20 can include a layer of the conducting layer or may also be a plurality of layers of conducting layers sequentially arranged in layer configuration. Exemplarily, the first conducting layer 20 includes a molybdenum layer and a copper layer. The adhesion of the molybdenum layer is better and is directly connected to the base plate 10, while the copper layer is formed at the side of the molybdenum layer away from the base plate 10, and the conductivity of the copper layer is better.

The patterned first conducting layer 20 includes the first electrode 21, the second electrode 22, the first electrode 21, and the second electrode 22 that are separately disposed. The separately disposing here refers to that in the first conducting layer 20, the first electrode 21 and the second electrode 22 are disconnected, and the first electrode 21 is not electrically connected to the second electrode 22.

Exemplarily, when the switch device is applied to the antenna, the first electrode 21 can be the antenna body, the second electrode 22 can be the extending line, or both the first electrode 21 and the second electrode 22 are the extending line.

Exemplarily, when the switch device is applied to the antenna, the first electrode 21, the second electrode 22, the antenna body and the extending line are disposed independently, and the first electrode 21 and the second electrode 22 are configured to be electrically connected to the antenna body or the extending line, respectively. For example, the first electrode 21 is connected to the antenna body, the second electrode 22 is connected to the extending line, or the first electrode 21 is connected to the extending line, and the second electrode 22 is connected to the other extending line.

The second conducting layer is a patterned conducting layer. The patterned second conducting layer includes an elastic arm 30, and the elastic arm 30 includes a connecting portion 31. The switch device includes two states of an opening state and a closing state. When the switch device is at the closing state, the connecting portion 31 is at the suspending state. The patterned first conducting layer 20 also includes a bottom electrode 23, in the direction perpendicular to the base plate 10, and there is a space disposed between the bottom electrode 23 and the connecting portion 31, to prevent the short connection between the bottom electrode 23 and the connecting portion 31.

The connecting portion 31 is elastic and can undergo elastic deformation. When the connecting portion 31 is subjected to an external force, the connecting portion 31 can undergo elastic deformation. When the external force is eliminated, the connecting portion 31 can rebound (such as restoring the original state). Exemplarily, the connecting portion 31 is made of metals with good elasticity (such as copper).

An orthographic projection of the bottom electrode 23 on the base plate and an orthographic projection of the connecting portion 31 on the base plate 10 at least partially overlaps. When a preset voltage is introduced between the connecting portion 31 and the bottom electrode 23, an electrostatic adsorption force is generated between the connecting portion 31 and the bottom electrode 23. Because the switch device is at the closing state, the connecting portion 31 is at the suspending state, and the bottom electrode 23 is located in the first conducting layer 20 (equivalent to that the bottom electrode 23 is fixed on the base plate 10), therefore the connecting portion 31 is made to be bent toward the bottom electrode 23 (that is, bent toward the first conducting layer 20) under an action of electrostatic adsorption.

Exemplarily, the positive charges are introduced into the bottom electrode 23, the negative charges are introduced into the connecting portion 31, and the bottom electrode 23 and the connecting portion 31 attract each other under the action of the electrostatic adsorption of the positive charges and the negative charges, so that the connecting portion 31 is bent toward the bottom electrode 23. Of course, it can also be that the negative charges are introduced into the bottom electrode 23 and the positive charges are introduced into the connecting portion 31.

The value of the preset voltage is not limited by the embodiments of the present disclosure, as long as the connecting portion 31 can be made to be bent toward the first conducting layer 20 under the action of the electrostatic adsorption. In practical application, it can be determined according to the elastic modulus of the connecting portion 31. The larger the elastic modulus of the connecting portion 31 is, the larger the preset voltage is.

When the switch device is applied to the antenna, a potential of the elastic arm 30 can be lower than a potential of the bottom electrode 23. The signal potential in the antenna is low, and the potential of the elastic arm 30 is lower than the potential of the bottom electrode 23, which can prevent the potential of the elastic arm 30 from generating interference on the signal in the antenna.

The orthographic projection of the connecting portion 31 on the first conducting layer 20 partially overlaps with the first electrode 21 and the second electrode 22. When the switch device is at the closing state, there are spaces between the connecting portion 31 and the first electrode 21, and between the connecting portion 31 and the second electrode 22 in the direction perpendicular to the base plate 10.

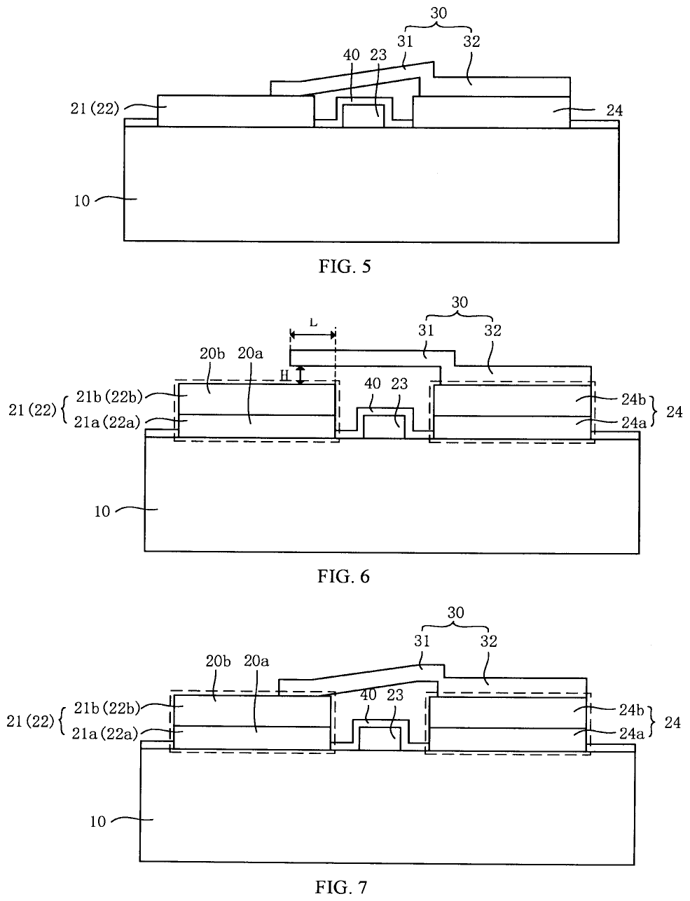

As shown in FIG. 4, when the switch device is at the closing state, because there are spaces between the connecting portion 31 and the first electrode 21, and between the connecting portion 31 and the second electrode 22, the connecting portion 31 cannot be electrically connected to the first electrode 21 and the second electrode 22, the first electrode 21 and the second electrode 22 are remained a disconnecting state. When the preset voltage is introduced between the connecting portion 31 and the bottom electrode 23, the connecting portion 31 is bent toward the first conducting layer 20 under the action of the electrostatic adsorption. Because the first electrode 21 and the second electrode 22 are located in the first conducting layer 20. The orthographic projection of the connecting portion 31 on the first conducting layer 20 partially overlaps with the first electrode 21 and the second electrode 22, which makes that after the connecting portion 31 is bent, the connecting portion is contacted with the first electrode 21 and the second electrode 22, thus the connecting portion 31 is made to be electrically connected to the first electrode 21 and the second electrode 22 at the same time, the first electrode 21 and the second electrode 22 are electrically connected through the connecting portion 31, and the switch device enters the opening state, as shown in FIG. 5.

When the switch device provided in the embodiments of the present disclosure is at the closing state, in a direction perpendicular to the base plate 10, and there are spaces between the connecting portion 31 and the first electrode 21, and between the connecting portion 31 and the second electrode 22, that is, the connecting portion 31 is not connected to the first electrode 21 and the second electrode 22. When the preset voltage is introduced between the connecting portion 31 and the bottom electrode 23, the electrostatic adsorption force is generated between the connecting portion 31 and the bottom electrode 23, so that the connecting portion 31 is bent toward the first conducting layer 20, thus the connecting portion is contacted with the first electrode 21 and the second electrode 22 that are located in the first conducting layer 20, the first electrode 21 and the second electrode 22 are electrically connected by using the connecting portion 31, and the switch device is changed from the closing state to the opening state.

The size L of the part of the connecting portion 31 facing the first electrode 21 or the second electrode 22 can be determined according to the space H between the connecting portion 31 and the first electrode 21 or between the connecting portion 31 and the second electrode 22, and the length of the connecting portion 31 along the horizontal direction shown in FIG. 2. As long as after the connecting portion 31 is bent, the connecting portion can be made to be contacted with the first electrode 21 and the second electrode 22 at the same time. In practical application, the size of L can be appropriately increased to increase the contact area of the connecting portion 31 with the first electrode 21 and the second electrode 22, thereby the resistance between the first electrode 21 and the second electrode 22 is reduced.

It should be noted that, in the embodiments of the present disclosure, it is schematically illustrated only by taking that the first electrode 21 and the second electrode 22 are disposed collinearly as an example. In practical application, the first electrode 21 and the second electrode 22 can also be disposed in parallel and separately, or in a certain angle.

In order to prevent the connecting portion 31 from being contacted with the bottom electrode 23 to generate short connection during the bending process of the connecting portion, one side of the bottom electrode 23 away from the base plate 10 can be provided with an insulating layer 40. The insulating layer 40 can be an organic insulating layer 40 or an inorganic insulating layer 40. Exemplarily, the insulating layer 40 is an inorganic insulating layer 40, which can be made of one or more materials of silicon nitride, silicon oxynitride and silicon oxide. The thickness of the insulating layer 40 can be determined according to the space between the connecting portion 31 and the bottom electrode 23. Exemplarily, the thickness of the insulating layer 40 is 20-500 nm.

In order to prevent the connecting portion 31 from being contacted with the bottom electrode 23 to generate short connection during the bending process of the connecting portion 31, a minimum distance between the first electrode 21 and the connecting portion 31, and between the second electrode 22 and the connecting portion 31 is less than a minimum distance between the bottom electrode 23 and the connecting portion 31, so that after the connecting portion 31 is bent, the connecting portion 31 is blocked by the first electrode 21 and the second electrode 22, and cannot continue to be bent toward the bottom electrode 23, to prevent the connecting portion 31 from being contacted with the bottom electrode 23.

As shown in FIG. 6 and FIG. 7, the first conducting layer 20 can include the first sub-conducting layer 20a and the second sub-conducting layer 20b, and the first sub-conducting layer 20a and the second sub-conducting layer 20b are sequentially arranged in layer configuration in the direction away from the base plate 10. The bottom electrode 23 can be located in the first sub-conducting layer 20a, and a position of the second sub-conducting layer 20b opposite to the bottom electrode 23 is hollow. That is, the first sub-conducting layer 20a, the second sub-conducting layer 20b, and the elastic arm 30 are sequentially arranged in layer configuration. When the bottom electrode 23 is located in the first sub-conducting layer 20a, there is a second sub-conducting layer 20b disposed between the bottom electrode 23 and the elastic arm 30, which makes that the distance between the bottom electrode 23 and the elastic arm 30 is larger and prevents the bottom electrode 23 from being contacted with the elastic arm 30.

When the first conducting layer 20 includes the first sub-conducting layer 20a and the second sub-conducting layer 20b, the first electrode 21 can include the first conducting structure 21b located in the second sub-conducting layer 20b, the second electrode 22 can include the second conducting structure 22b located in the second sub-conducting layer 20b. When the preset voltage is introduced between the elastic arm 30 and the bottom electrode 23, the connecting portion 31 is electrically connected to the first conducting structure 21b and the second conducting structure 22b. The first conducting structure 21b and the second conducting structure 22b that are used to be contacted with the connecting portion 31 are located in the second sub-conducting layer 20b, and the bottom electrode 23 is located in the first sub-conducting layer 20a. The first sub-conducting layer 20a and the second sub-conducting layer 20b are sequentially disposed in the direction away from the base plate 10, so that after the connecting portion 31 is bent, the connecting portion is blocked by the first conducting structure 21b and the second conducting structure 22b, and cannot continue to bend toward the bottom electrode 23, to prevent the connecting portion 31 from being contacted with the bottom electrode 23.

Exemplarily, the first electrode 21 also includes a third conducting structure 21a located in the first sub-conducting layer 20a, and the third conducting structure 21a is connected to the first conducting structure 21b in layer configuration; and/or, the second electrode 22 also includes the fourth conducting structure 22a located in the first sub-conducting layer 20a, and the fourth conducting structure 22a is connected to the second conducting structure 22b in layer configuration. The first electrode 21 includes the first conducting structure 21b and the third conducting structure 21a, and the second electrode 22 includes the second conducting structure 22b and the fourth conducting structure 22a, so that the cross-sectional areas of the first electrode 21 and the second electrode 22 are increased, and the resistance between the first electrode 21 and the second electrode 22 is reduced.

The material of the first sub-conducting layer 20a and the material of the second sub-conducting layer 20b can be the same or different. The thickness of the first sub-conducting layer 20a and the thickness of the second sub-conducting layer 20b can be between 0.2 μm and 5 μm, respectively.

Continuing to refer to FIG. 4 to FIG. 7, the elastic arm 30 can include a fixing portion 32 connected to the connecting portion 31, the fixing portion 32 is fixed on the base plate 10. Wherein the fixing portion 32 can be directly fixed on the base plate 10, or can be fixed on the base plate 10 by using other structures. The connecting position between the connecting portion 31 and the fixing portion 32 is used to support the connecting portion 31. The connecting portion 31 is suspended except the part of the connecting portion connected to the fixing portion 32, so that the connecting portion 31 can be bent around the connecting position between the connecting portion 31 and the fixing portion 32.

The fixing portion 32 is connected to the connecting portion 31. The fixing portion 32 is located in the second conducting layer and can conduct electricity, and the fixing portion 32 is fixed on the base plate 10 without bending or displacement during the working process. Therefore, the charges are made to be introduced into the connecting portion 31 by the method that the charges are introduced into the fixing portion 32.

Continuing to refer to FIG. 4 to FIG. 7, the first conducting layer 20 can include an anchoring structure 24, the fixing portion 32 of the elastic arm 30 is connected to the anchoring structure 24. Exemplarily, as shown in FIG. 6 and FIG. 7, when the first conducting layer 20 includes the first sub-conducting layer 20a and the second sub-conducting layer 20b. The anchoring structure 24 can include the first sub-anchoring structure 24a and the second sub-anchoring structure 24b. The first sub-anchoring structure 24a is connected to the base plate 10, and the second sub-anchoring structure 24b is connected to the fixing portion 32. Wherein the fixing portion 32 can be directly connected to the anchoring structure 24, and can also be connected to the anchoring structure 24 through other film layers.

a. the fixing portion 32 is directly connected to the anchoring structure 24.

The first electrode 21, the second electrode 22 and the anchoring structure 24 are all located in the first conducting layer 20, so that sides that are away from the base plate 10 of the first electrode 21, the second electrode 22 and the anchoring structure 24 are aligned. There are spaces between the connecting portion 31 and the first electrode 21, and between the connecting portion 31 and the second electrode 22, that is, there is a space between the connecting portion 31 and the anchoring structure 24, while the fixing portion 32 is directly connected to the anchoring structure 24. Therefore, the distance between the side face of the fixing portion 32 away from the base plate 10 and the base plate 10 is less than the distance between the side face of the connecting portion 31 away from the base plate 10 and the base plate 10, that is, there is a mismatch between the connecting portion 31 and the fixing portion 32.

Comparing with that the fixing portion 32 is directly connected to the base plate 10, when the fixing portion 32 is directly connected to the anchoring structure 24, the mismatch between the fixing portion 32 and the connecting portion 31 is reduced to prevent that during the manufacturing process of the switch device, the connection between the connecting portion 31 and the fixing portion 32 is disconnected due to the excessive mismatch.

Moreover, the anchoring structure 24 is located in the first conducting layer 20 and can conduct electricity. The charges can be introduced into the anchoring structure 24, so that the charges enters the connecting portion 31 from the anchoring structure 24 and the fixing portion 32, sequentially. Exemplarily, the first conducting layer 20 also includes the connecting line 25, one end of the connecting line 25 is electrically connected to the anchoring structure 24, and the other end of the connecting line is configured to receive the controlling signal.

During manufacturing the switch device, it is necessary to dispose the sacrificial material at the side of the connecting portion 31 toward the base plate 10, and then after the second conducting layer is deposited on the sacrificial material, and the connecting portion 31 is formed by patterning the second conducting layer, the sacrificial material located at the side of the connecting portion 31 toward the base plate 10 is removed, so that the connecting portion 31 is suspended.

The second space can be disposed between the anchoring structure 24 and the first electrode 21, and between the anchoring structure 24 and the second electrode 22. The connecting position between the connecting portion 31 and the fixing portion 32 is located in the second space, resulting in that the space H between the connecting portion 31 and the first electrode 21, and between the anchoring structure 24 and the second electrode 22 may be reduced. When the space H is too small and the preset voltage is not applied, the connecting portion 31 may also be contacted with the first electrode 21 and the second electrode 22, so that the switch device fails.

Therefore, it is necessary to avoid the connecting position between the connecting portion 31 and the fixing portion 32 from being located in the first space. In view of this, the orthographic projection on the base plate 10 of the connecting position between the connecting portion 31 and the fixing portion 32 needs to be located within the range of the orthographic projection of the anchoring structure 24 on the base plate 10. That is, the orthographic projection of the fixing portion 32 on the base plate 10 is located within the range of the orthographic projection of the anchoring structure 24 on the base plate 10.

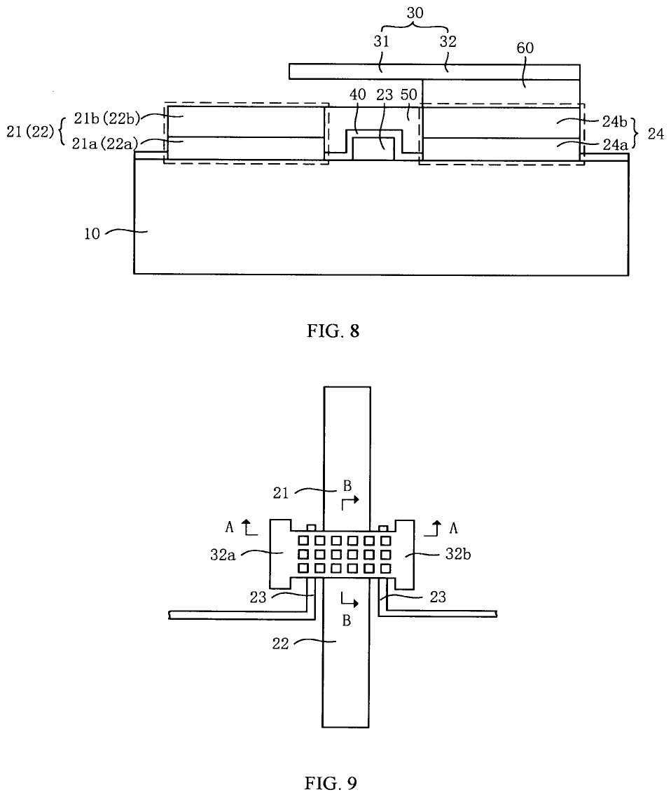

b, as shown in FIG. 8, there is also a sacrificial layer 60 disposed between the fixing portion 32 and the anchoring structure 24.

Exemplarily, the thickness of the sacrificial layer 60 is equal to the space H between the connecting portion 31 and the first electrode 21 and the second electrode 22. At this moment, the distance between the side face of the fixing portion 32 away from the base plate 10 and the base plate 10 is equal to the distance between the side face of the connecting portion 31 away from the base plate 10 and the base plate 10, that is, the elastic arm 30 as a whole is parallel to the base plate 10 to prevent the connection between the fixing portion 32 and the connecting portion 31 from being disconnected due to the existence of mismatch.

Of course, the thickness of the sacrificial layer 60 can also be greater than or less than the space between the connecting portion 31 and the first electrode 21, and between the connecting portion 31 and the second electrode 22. When the thickness of the sacrificial layer 60 is less than the space H between the connecting portion 31 and the first electrode 21, and between the connecting portion 31 and the second electrode 22, in the direction perpendicular to the base plate 10, the distance between the surface of one side of the connecting portion 31 away from the base plate 10 and the base plate 10 is greater than or equal to the distance between the surface of one side of the fixing portion 32 away from the base plate 10 and the base plate 10, in this way, the thickness of the switch device at the anchoring structure 24 is made thinner.

During manufacturing the switch device, it is necessary to dispose the sacrificial material at the side of the connecting portion 31 toward the base plate 10, and then after the second conducting layer is deposited on the sacrificial material, and the connecting portion 31 is formed by patterning the second conducting layer, the sacrificial material located at the side of the connecting portion 31 toward the base plate 10 is removed, so that the connecting portion 31 is suspended. The sacrificial layer 60 is formed by the unremoved sacrificial material.

The first conducting layer 20 is provided with a hollow region. For example, there is first space disposed between the first electrode 21 and the second electrode 22, there is second space disposed between the anchoring structure 24 and the first electrode 21, and between the anchoring structure 24 and the second electrode 22. The first space and the second space are hollow (without conducting materials being disposed) to form the hollow region.

The overlapping region of the orthographic projection of the connecting portion 31 on the base plate 10 and an orthographic projection of the hollow region on the base plate 10 is provided with a planarization layer 50; and sides that are away from the base plate 10 of the planarization layer 50, the first electrode 21, the second electrode 22 and the anchoring structure 24 are aligned. The sides that are away from the base plate 10 of the planarization layer 50, the first electrode 21, the second electrode 22 and the anchoring structure 24 form a flat plane together. After the sacrificial material is formed on this plane, it is also relatively flat, which further makes the elastic arm 30 formed in the sacrificial material is also relatively flat.

In the above two cases of a and b, it is necessary to etch the sacrificial material of the side of the connecting portion 31 facing the base plate 10. In order to improve the etching effect, as shown in FIG. 3, the connecting portion 31 can be provided with a releasing hole 33, and the releasing hole 33 penetrates through the connecting portion 31 in the direction perpendicular to the base plate 10. During manufacturing the switch device, the sacrificial material can be etched by using the releasing hole 33.

Of course, the releasing hole 33 can also not be disposed through wet etching or dry etching.

The releasing hole 33 can have a variety of shapes, such as a circular hole, a square hole, a rectangular hole, etc. The shape of the releasing hole 33 is not limited in the embodiments of the present disclosure.

The size of the releasing holes 33 can be the same or different. In practical application, it can be determined according to the size of the connecting portion 31. When the distance from the releasing hole 33 located at the edge of the connecting portion 31 to the edge of the connecting portion 31 is large, the size of the releasing hole 33 can be increased to increase the releasing effect of the sacrificial material. Exemplarily, the width of the connecting portion 31 is 82 um and the length of the connecting portion 31 is 300 μm. The size of the releasing holes 33 in the middle area of the connecting portion 31 is 6*6 μm, and the size of the releasing hole 33 at the edge of the connecting portion 31 is 6*11 μm. The hole spacing between the two adjacent releasing holes is 8 μm.

The connecting portion 31 can include the first end and the second end. The fixing portion 32 is connected to the first end of the connecting portion 31, and the second end of the connecting portion 31 is suspended. Exemplarily, as shown in FIG. 3 to FIG. 8, the connecting portion 31 is rectangular, with the first end and the second end being disposed oppositely. Of course, the connecting portion 31 can also be other polygons, arcs, and other irregular shapes. The first end and the second end may also not be disposed oppositely, but have a certain angle. For example, the connecting portion 31 is L-shaped, the first end of the connecting portion 31 is connected to the fixing portion 32, and the other end of the connecting portion 31 is suspended.

When the second end of the connecting portion 31 is suspended, under a certain elastic modulus of the connecting portion 31, the connecting portion 31 is more prone to generating elastic deformation, and a smaller preset voltage can drive the connecting portion 31 to bend, to prevent excessive preset voltage from causing breakdown between the connecting portion 31 and the first electrode 21, between the connecting portion 31 and the second electrode 22 or between the connecting portion 31 and the bottom electrode 23.

The fixing portion 32 can include a first fixing portion 32a and a second fixing portion 32b. The first fixing portion 32a and the second fixing portion 32b are separately disposed, and the connecting portion 31 is connected between the first fixing portion 32a and the second fixing portion 32b. The plurality of fixing portions 32 are connected to the connecting portion 31 at the same time, so that the connection of the connecting portion 31 is more stable. During manufacturing or using the switch device, after the connecting portion 31 is disconnected to one of the fixing portions 32, and the other fixing portion 32 can support the connecting portion 31, the reliability of the switch device is improved.

In the first electrode 21 and the second electrode 22, the area used to contact with the connecting portion 31 is the contacting portion. The first fixing portion 32a and the second fixing portion 32b can be located at the same side of the contacting portion. It may also be that the contacting portion is located between the first fixing portion 32a and the second fixing portion 32b.

When the first fixing portion 32a and the second fixing portion 32b can be located at the same side of the contacting portion. Exemplarily, the connecting portion 31 is a semicircular ring, the first fixing portion 32a is connected to one end of the semicircular ring, the second fixing portion 32b is connected to the other end of the semicircular ring, and the middle area of the semicircular ring is used to contact with the first electrode 21 and the second electrode 22. At this moment, the two end portion of the connecting portion 31 are connected to the fixing portion 32, the rebound force of the connecting portion 31 after deformation is increased to prevent the connecting portion 31 from not rebounding in time after the preset voltage is eliminated, and the response time of the switch device is reduced.

When the contacting portion is located between the first fixing portion 32a and the second fixing portion 32b, exemplarily, as shown in FIG. 9 to FIG. 11, the shape of the connecting portion 31 is a strip across the first electrode 21 and the second electrode 22. At this moment, as shown in the figures, the left end of the connecting portion 31 is connected to the first fixing portion 32a, and the right end of the connecting portion 31 is connected to the second fixing portion 32b, the rebound force of the connecting portion 31 after deformation is increased to prevent the connecting portion 31 from not rebounding in time after the preset voltage is eliminated, and the response time of the switch device is reduced.

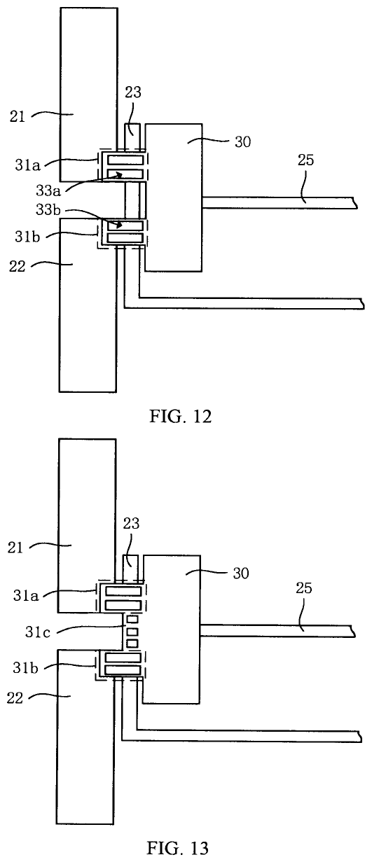

As shown in FIG. 12, the connecting portion 31 can include the first elastic sheet 31a and the second elastic sheet 31b that are connected to the fixing portion 32, respectively. The first elastic sheet 31a is configured to be electrically connected to the first electrode 21, and the second elastic sheet 31b is configured to be electrically connected to the second electrode 22. In the direction parallel to the base plate 10, the first elastic sheet 31a and the second elastic sheet 31b are separately disposed.

Exemplarily, the space between the first elastic sheet 31a and the second elastic sheet 31b is disposed oppositely to the first space between the first electrode 21 and the second electrode 22.

The connecting portion 31 is divided into the first elastic sheet 31a and the second elastic sheet 31b that are disposed oppositely. The first elastic sheet 31a and the second elastic sheet 31b can be bent under the action of the bottom electrode 23, respectively. Comparing with the conducting sheet that the connecting portion 31 is disposed as a whole, the first elastic sheet 31a and the second elastic sheet 31b are more prone to generating elastic deformation, and the lower preset voltage can drive the first elastic sheet 31a and the second elastic sheet 31b to be bent.

As shown in FIG. 13, the connecting portion 31 also includes a strengthening portion 31c connected between the first elastic sheet 31a and the second elastic sheet 31b, and strengthening portion 31c is directly connected to the fixing portion 32. The strengthening portion 31c is connected to the first elastic sheet 31a and the second elastic sheet 31b, at the same time, the structural stiffness of the first elastic sheet 31a and the second elastic sheet 31b can be increased, after the preset voltage is eliminated, the first elastic sheet 31a and the second elastic sheet 31b are more prone to rebounding, the rebounding speed is faster, and the response speed of the switch device is improved.

It should be noted that it is schematically illustrated only by taking the case in which one end of the connecting portion 31 is suspended and the other end of the connecting portion is fixedly connected as an example. It can be understood that when the connecting portion 31 is connected to the first fixing portion 32a and the second fixing portion 32b, the connecting portion 31 can also include the first elastic sheet 31a and the second elastic sheet 31b, which are not repeated here.

As shown in FIG. 12 to FIG. 14, the releasing hole 33 can include a strip hole extending from the fixing portion 32 toward the first electrode 21 or the second electrode 22. Exemplarily, as shown in FIG. 12, when the connecting portion 31 includes the first elastic sheet 31a and the second elastic sheet 31b, the releasing hole 33 includes the first releasing hole 33a located in the first elastic sheet 31a and the second releasing hole 33b located in the second elastic sheet 31b. The first releasing hole 33a is extended from the fixing portion 32 to the first electrode 21, and the second releasing hole 33b is extended from the fixing portion 32 to the second electrode 22. Because a part of the material of the first elastic sheet 31a is hollowed out by the first releasing hole 33a, and a part of the material of the second elastic sheet 31b is hollowed out by the second releasing hole 33b, the first elastic sheet 31a and the second elastic sheet 31b are more prone to generating elastic deformation, the value of the preset voltage is reduced.

Of course, as shown in FIG. 15, the capacity of the elastic deformability capacity of the connecting portion 31 can also be increased by increasing the size of the connecting portion 31 from the fixing portion 32 to the first electrode 21 or the second electrode 22 (the size in the horizontal direction as shown in FIG. 15).

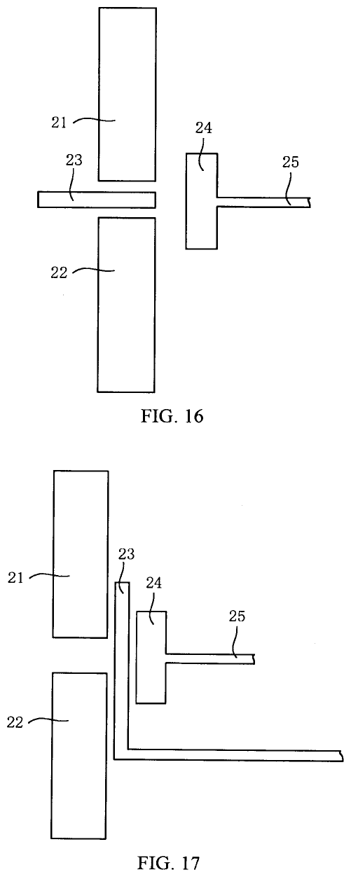

The positions used to dispose the bottom electrode 23 can be more than one. As shown in FIG. 16 to FIG. 19, the bottom electrode 23 can be located in the first space, can also be located in second space, or can also be located in both the first space and the second space at the same time. The larger the overlapping area between the bottom electrode 23 and the connecting portion 31 is, the greater the interaction force between the bottom electrode 23 and the connecting portion 31 is, under the same preset voltage.

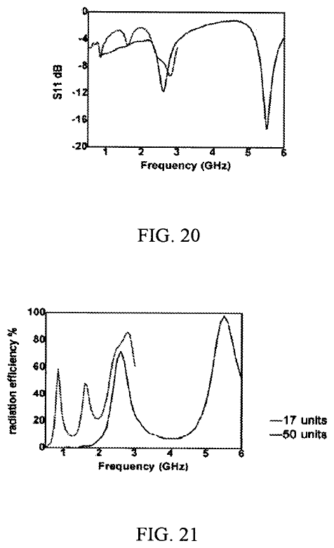

When the switch device is applied to the antenna, exemplarily, the antenna can include 50 switch devices and the antenna bodies and the extending lines corresponding the switch devices. When 17 switch devices are at the opening state under the control of the controlling signal, 17 extending lines are connected to the antenna bodies, and the antenna fundamental mode is near 2.5 GHZ, as shown in the S11 parameter diagram and the radiation efficiency diagram in FIG. 20. When 50 switch devices are at the opening state under the control of the controlling signal, 50 extending lines are connected to the antenna bodies. The antenna fundamental mode is near 850 MHz, and the radiation frequency of the antenna fundamental mode obviously moves to the low frequency (as shown in FIG. 21), thus the effect of frequency modulation is achieved.

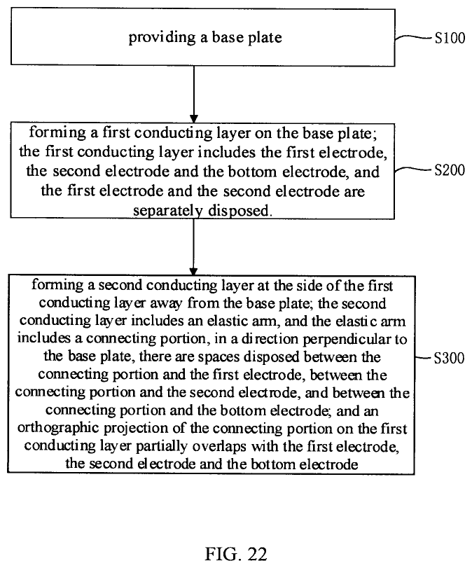

A method for manufacturing a switch device is further provided by the embodiments of the present disclosure. As shown in FIG. 22, the manufacturing method can include the following steps.

S100, providing a base plate.

The base plate can be a rigid base plate or can also be a flexible base plate. When the base plate is a rigid base plate, the rigid base plate can be a glass base plate, a plastic base plate or a printed circuit board (PCB), etc. When the base plate 10 is a flexible base plate, the materials that form the flexible base plate can be PI (polyimide), PET (polyethylene glycol terephthalate), ultra-thin glass, etc.

S200, forming a first conducting layer on the base plate; the first conducting layer includes the first electrode, the second electrode and the bottom electrode, and the first electrode and the second electrode are separately disposed.

The first conducting layer is fabricated on the base plate by the magnetron sputtering or a method of combining the magnetron sputtering with the electroplating, and the first conducting layer is patterned to form the first electrode, the second electrode and the bottom electrode. The first conducting layer can include a layer of metal layer or the metal layers with a plurality of layers being arranged in layer configuration. The thickness of each metal layer can be in the range of 0.2-5 μm.

Exemplarily, step S200 can include the following steps:

S210, forming the first sub-conducting layer on base plate;

S220, patterning the first sub-conducting layer to form the first conducting structure, the second conducting structure and the bottom electrode;

S230, forming an insulating layer on the first sub-conducting layer; and the thickness of the insulating layer is between 20 nm and 500 nm.

S240, etching the insulating layer on the first conducting structure and the second conducting structure;

S250, forming a second sub-conducting layer at the side of the first sub-conducting layer away from the base plate;

S260, patterning the second sub-conducting layer to form the third conducting structure and the fourth conducting structure, and the third conducting structure and the first conducting structure are connected in layer configuration to form the first electrode. The fourth conducting structure and the second conducting structure are connected in layer configuration to form the second electrode.

Exemplarily, the first conducting layer further includes an anchoring structure.

S300, forming a second conducting layer at the side of the first conducting layer away from the base plate; the second conducting layer includes an elastic arm, and the elastic arm includes a connecting portion, in a direction perpendicular to the base plate, there are spaces disposed between the connecting portion and the first electrode, between the connecting portion and the second electrode, and between the connecting portion and the bottom electrode; and an orthographic projection of the connecting portion on the first conducting layer partially overlaps with the first electrode, the second electrode and the bottom electrode.

Wherein step S300 can include the following steps:

S310, forming a sacrificial material at the side of the first conducting layer away from the base plate;

The sacrificial material can be photoresist, optical transparent adhesive and other materials. The thickness of the sacrificial material can be greater than the thickness of the first conducting layer to make the sacrificial material play a role in flattening. Exemplarily, the thickness of the sacrificial material is 1-10 μm.

Exemplarily, the sacrificial material partially overlaps with the anchoring structure, and the sizes of the overlapping area along the fixing portion toward the directions of the first electrode and the second electrode is 3-10 μm.

S320, forming a second conducting layer on the sacrificial material;

The thickness of the second conducting layer can be 100 nm-5 μm.

S330, patterning the second conducting layer to form the elastic arm;

S340, etching the sacrificial material at the side of the connecting portion toward the base plate, so that there are spaces between the connecting portion and the first electrode, and between the connecting portion and the second electrode.

Exemplarily, the sacrificial material can be etched by wet etching, such as soaking by using solvents such as acetone or degumming solution, or etching the sacrificial material by dry etching.

The switch device manufactured by using the method for manufacturing the switch device provided by the embodiments of the present disclosure is at the closing state, in the direction perpendicular to the base plate, there are spaces between the connecting portion and the first electrode, and between the connecting portion and the second electrode, that is, the connecting portion is not connected to the first electrode and the second electrode. When the preset voltage is introduced between the connecting portion and the bottom electrode, the electrostatic adsorption force is generated between the connecting portion and the bottom electrode, so that the connecting portion is bent toward the first conducting layer, thus the connecting portion is contacted with the first electrode and the second electrode located in the first conducting layer, the first electrode and the second electrode are electrically connected by the connecting portion, and the switch device is changed from the closing state to the opening state.

The above-described apparatus embodiments are merely illustrative, wherein the units that are described as separate components may or may not be physically separate, and the components that are displayed as units may or may not be physical units; in other words, they may be located at the same one location, and may also be distributed to a plurality of network units. Part or all modules therein may be selected according to actual needs to realize the objective of achieving the technical solution of the embodiment. A person skilled in the art can understand and implement the technical solutions without paying creative work.

The “one embodiment”, “an embodiment” or “one or more embodiments” as used herein means that particular features, structures or characteristics described with reference to an embodiment are included in at least one embodiment of the present disclosure. Moreover, it should be noted that here an example using the wording “in an embodiment” does not necessarily refer to the same one embodiment.

Many details are discussed in the specification provided herein. However, it can be understood that the embodiments of the present disclosure may be implemented without those concrete details. In some of the embodiments, well-known processes, structures and techniques are not described in detail, so as not to affect the understanding of the description.

In the claims, any reference signs between parentheses should not be construed as limiting the claims. The word “include” does not exclude elements or steps that are not listed in the claims. The word “a” or “an” preceding an element does not exclude the existing of a plurality of such elements. The present disclosure may be implemented by means of hardware including several different elements and by means of a properly programmed computer. In unit claims that list several devices, some of those apparatuses may be embodied by the same item of hardware. The words first, second, third and so on do not denote any order. Those words may be interpreted as names.

Finally, it should be noted that the above embodiments are merely intended to explain the technical solutions of the present disclosure, and not to limit them. Although the present disclosure is explained in detail by referring to the above embodiments, a person skilled in the art should understand that he can still modify the technical solutions set forth by the above embodiments, or make equivalent substitutions to part of the technical features of them. However, those modifications or substitutions do not make the essence of the corresponding technical solutions depart from the spirit and scope of the technical solutions of the embodiments of the present disclosure.

1. A switch device, wherein the switch device comprises a base plate, a first conducting layer and a second conducting layer, the first conducting layer and the second conducting layer are sequentially arranged in layer configuration on the base plate, the first conducting layer comprises a first electrode, a second electrode and a bottom electrode and the second conducting layer comprises an elastic arm;
the first electrode and the second electrode are separately disposed, the elastic arm comprises a connecting portion; in a direction perpendicular to the base plate, there are spaces disposed between the connecting portion and the first electrode, between the connecting portion and the second electrode, and between the connecting portion and the bottom electrode; and an orthographic projection of the connecting portion on the first conducting layer partially overlaps with the first electrode and the second electrode; and
the orthographic projection of the connecting portion on the first conducting layer partially overlaps with the bottom electrode; when a preset voltage is introduced between the connecting portion and the bottom electrode, the connecting portion is configured to bend toward the first electrode and the second electrode, and be electrically connected to the first electrode and the second electrode, respectively.

2. The switch device according to claim 1, wherein the elastic arm further comprises a fixing portion connected to the connecting portion, and the fixing portion is fixed on the base plate.

3. The switch device according to claim 2, wherein the connecting portion comprises a first end and a second end, the fixing portion is connected to the first end of the connecting portion, and the second end of the connecting portion is suspended.

4. The switch device according to claim 2, wherein the fixing portion comprises a first fixing portion and a second fixing portion, and the connecting portion is connected between the first fixing portion and the second fixing portion.

5. The switch device according to claim 4, wherein the first electrode and the second electrode both comprise a contacting portion, and the contacting portion is configured to be electrically connected to the connecting portion; and the contacting portion is located between the first fixing portion and the second fixing portion.

6. The switch device according to claims 2, wherein the first conducting layer further comprises an anchoring structure, and the fixing portion of the elastic arm is connected to the anchoring structure.

7. The switch device according to claim 6, wherein a sacrificial layer is further disposed between the fixing portion and the anchoring structure.

8. The switch device according to claim 7, wherein the first conducting layer is provided with a hollow region, and an overlapping region of an orthographic projection of the connecting portion on the base plate and an orthographic projection of the hollow region on the base plate is provided with a planarization layer; and sides that are away from the base plate of the planarization layer, the first electrode, the second electrode and the anchoring structure are aligned.

9. The switch device according to claim 6, wherein the fixing portion is directly connected to one side of the anchoring structure away from the base plate.

10. The switch device according to claim 9, wherein in the direction perpendicular to the base plate, a distance between a surface of one side of the connecting portion away from the base plate and the base plate is greater than or equal to a distance between a surface of one side of the fixing portion away from the base plate and the base plate.

11. The switch device according to claim 10, wherein an orthographic projection of the fixing portion on the base plate is located within a range of an orthographic projection of the anchoring structure on the base plate.

12. The switch device according to claim 1, wherein the connecting portion comprises a first elastic sheet and a second elastic sheet that are connected to the fixing portion, respectively, and the first elastic sheet is configured to be electrically connected to the first electrode; the second elastic sheet is configured to be electrically connected to the second electrode; in a direction parallel to the base plate, the first elastic sheet and the second elastic sheet are separately disposed.

13. The switch device according to claim 12, wherein the connecting portion further comprises a strengthening portion connected between the first elastic sheet and the second elastic sheet, and the strengthening portion is directly connected to the fixing portion.

14. The switch device according to claim 1, wherein the connecting portion of the elastic arm is provided with a releasing hole, and the releasing hole penetrates through the connecting portion in the direction perpendicular to the base plate.

15. The switch device according to claim 14, wherein the releasing hole comprises a strip hole extending from the fixing portion toward the first electrode or the second electrode.

16. The switch device according to claim 6, wherein there is a first space disposed between the first electrode and the second electrode, and there is a second space disposed between the anchoring structure and the first electrode, and between the anchoring structure and the second electrode; and the bottom electrode is located in the first space and/or the second space.

17. The switch device according to claim 1, wherein a minimum distance between the first electrode and the connecting portion, and between the second electrode and the connecting portion is less than a minimum distance between the bottom electrode and the connecting portion.

18-19. (canceled)

20. An antenna, wherein the antenna comprises a plurality of switch devices according to claims 1, the plurality of switch devices are arranged in an array, and the second electrode of the switch device is electrically connected to the first electrode of adjacent switch device; wherein the first electrode or the second electrode of one of the plurality of switch devices is configured to be electrically connected to a feeder line.

21. (canceled)

22. An antenna, wherein the antenna comprises a base plate and a first conducting layer and a switch device that are disposed on the base plate;
the first conducting layer comprises an antenna body and an extending line, one end of the antenna body is configured to be electrically connected to a feeder line, and the other end of the antenna body and the extending line are separately disposed; and
the switch device is located at an interval between the antenna body and the extending line, and is configured to be electrically connected or disconnected to the antenna body and the extending line under control of the controlling signal to change an electrical length of the antenna.

23. An electronic device, wherein the electronic device comprises the antenna according to claim 20.
